(19) United States
(12) Patent Application Publication
(10) Pub. No.: US 2014/0214717 A1
(43) Pub. Date: Jul. 31, 2014

(54) SYSTEM AND METHOD FOR MEASURING AND MONITORING PRODUCT AND SERVICE EFFECTIVENESS

(71) Applicant: Valorie Sharron Valencia, Phoenix, AZ (US)

(72) Inventor: Valorie Sharron Valencia, Phoenix, AZ (US)

(21) Appl. No.: 14/169,755

(22) Filed: Jan. 31, 2014

Related U.S. Application Data
(60) Provisional application No. 61/759,254, filed on Jan. 31, 2013.

(51) Int. Cl. G06Q 30/02

(52) U.S. Cl. CPC G06Q 30/0282
USPC 705/347

(57) ABSTRACT

A system to measure and monitor product and service effectiveness is disclosed. The system may include a plurality of assessment statements ratings that include a before system rating and an after system rating and present an assessment quiz result back to a user in real time while allowing the user to take the assessment quiz as often as desired. The system may also include a method for measuring and monitoring product and service effectiveness that includes the steps of accessing a provider's website, accessing a plurality of assessment statements on a database run by a data analysis non-transitory storage media and accessing a results dashboard with a plurality of compiled user results.

This application claims priority to U.S. Provisional Application No. 61/759,254, filed on Jan. 31, 2013, the entire disclosure of which is incorporated by reference.

### BACKGROUND OF THE INVENTION

The present invention generally relates to a system and method for measuring and monitoring. More specifically, the present invention is a system and method for measuring and monitoring product and service effectiveness.

Businesses currently have several ways to measure customer satisfaction but have no practical method to measure product and service effectiveness. Many businesses solicit subjective testimonials from customers, which measures customer satisfaction but is not indicative of product or service effectiveness. Businesses may commission objective, third-party double-blind, randomized, placebo-based clinical trials to prove product or service effectiveness, but such scientific studies are expensive, time consuming, and impractical for many businesses.

### SUMMARY OF THE INVENTION

The present invention generally relates to a system and method for measuring and monitoring. More specifically, the present invention is a system and method for measuring and monitoring product and service effectiveness.

The system to measure and monitor product and service effectiveness includes a server system with a processor system, a communications interface, a communications system, an input system and an output system, the server system having access to a communications network, a memory system with an operating system, a communications module, a web browser module, a web server application and a product and service effectiveness non-transitory storage media and a website with a plurality of web pages to measure and monitor product and service effectiveness.

The method for measuring and monitoring product and service effectiveness includes the steps of accessing a welcome webpage, submitting a plurality of assessment statements, responding to one or more optional queries and logging-in and viewing current results and a plurality of past results.

It is an object of the present invention to provide a system and method for measuring and monitoring product and service effectiveness that provides businesses, and their customers, a system and method to measure and monitor product and service effectiveness over time.

It is an object of the present invention to provide a system and method for measuring and monitoring product and service effectiveness that bridges the gap between subjective testimonials and objective double-blind clinical trials by providing online assessment quizzes that end customers take both before and after experiencing a business's product or service.

It is an object of the present invention to provide a system and method for measuring and monitoring product and service effectiveness that provides assessment quiz results back to a user in real time and as often as desired.

It is an object of the present invention to provide a system and method for measuring and monitoring product and service effectiveness that provides meaningful effectiveness feedback to businesses and their consumers and is practical for and accessible to most any product or service provider.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system to measure and monitor product and service effectiveness, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 3 illustrates a screenshot of a pair of sample assessment statements, in accordance with one embodiment of the present invention.

FIG. 4 illustrates a screenshot of a plurality of personalized results feedback, in accordance with one embodiment of the present invention.

FIG. 5 illustrates a table of a plurality of score-based feedback, in accordance with one embodiment of the present invention.

FIG. 6 illustrates a flowchart of a method for measuring and monitoring product and service effectiveness as experienced by a new user, in accordance with one embodiment of the present invention.

FIG. 7 illustrates a screenshot of a set of categorized graphical results, in accordance with one embodiment of the present invention.

FIG. 8 illustrates a flowchart of a method for measuring and monitoring product and service effectiveness as experienced by a return user, in accordance with one embodiment of the present invention.

FIG. 9 illustrates a screenshot of two sets of categorized graphical results, in accordance with one embodiment of the present invention.

FIG. 10 illustrates a flowchart of a method for measuring and monitoring product and service effectiveness as experienced by a return user accessing past results, in accordance with one embodiment of the present invention.

FIG. 11 illustrates an overview flowchart of the method for measuring and monitoring product and service effectiveness, in accordance with one embodiment of the present invention.

FIG. 12 illustrates a block diagram of a product and service effectiveness non-transitory storage media, in accordance with one embodiment of the present invention.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

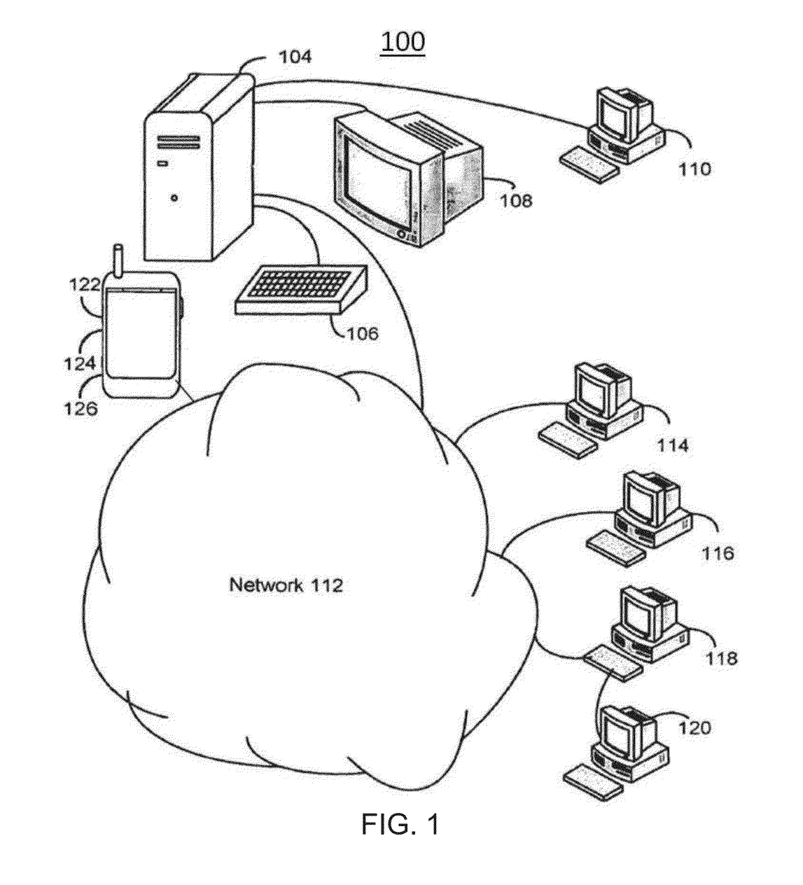

FIG. 1 illustrates a system overview of a system 100 to measure and monitor product and service effectiveness. The system 100 may include a server system 104, an input system 106, an output system 108, a plurality of client systems 110, 114, 116, 118 and 120, a communications network 112 and a handheld or mobile device 122. In other embodiments, the system 100 may include additional components and/or may not include all of the components listed above.

The server system 104 may include one or more servers. One server 104 may be the property of the distributor of any related software. In other embodiments, the system 100 may include additional components and/or may not include all of the components listed above.

The input system 106 may be utilized for entering input into the server system 104, and may include any one of, some of, any combination of, or all of a keyboard system, a mouse system, a track ball system, a track pad system, a plurality of buttons on a handheld system, a mobile system, a scanner system, a wireless receiver, a microphone system, a connection to a sound system, and/or a connection and/or an interface system to a computer system, an intranet, and/or the Internet (i.e., IrDA, USB).

The output system 108 may be utilized for receiving output from the server system 104, and may include any one of, some of, any combination of or all of a monitor system, a wireless transmitter, a handheld display system, a mobile display system, a printer system, a speaker system, a connection or an interface system to a sound system, an interface system to one or more peripheral devices and/or a connection and/or an interface system to a computer system, an intranet, and/or the Internet.

The system 100 illustrates some of the variations of the manners of connecting to the server system 104, which may be an information providing website (not shown). The server system 104 may be directly connected and/or wirelessly connected to the plurality of client systems 110, 114, 116, 118 and 120 and may be connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 may be any system that an end user may utilize to access the server system 104. For example, the client systems 110, 114, 116, 118 and 120 may be personal computers, workstations, laptop computers, game consoles, handheld network enabled audio/video players, mobile devices and/or any other network appliance.

The client system 120 may access the server system 104 via the combination of the communications network 112 and another system, which in this example may be the client system 118. The client system 120 may be a handheld or mobile wireless device 122, such as a mobile phone, tablet or a handheld network-enabled audio/music player, which may also be utilized for accessing network content. The client system 120 may be a cell phone with an operating system or SMARTPHONE® 124 or a tablet with an operating system or IPAD® 126.

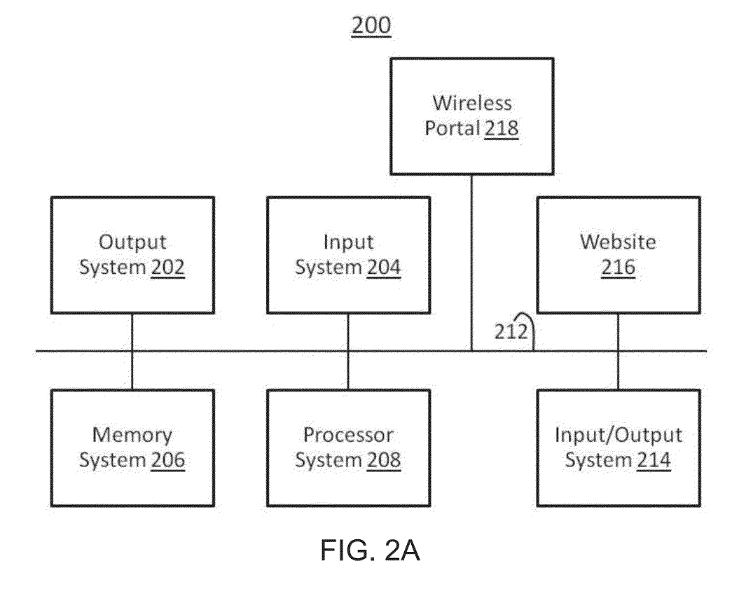

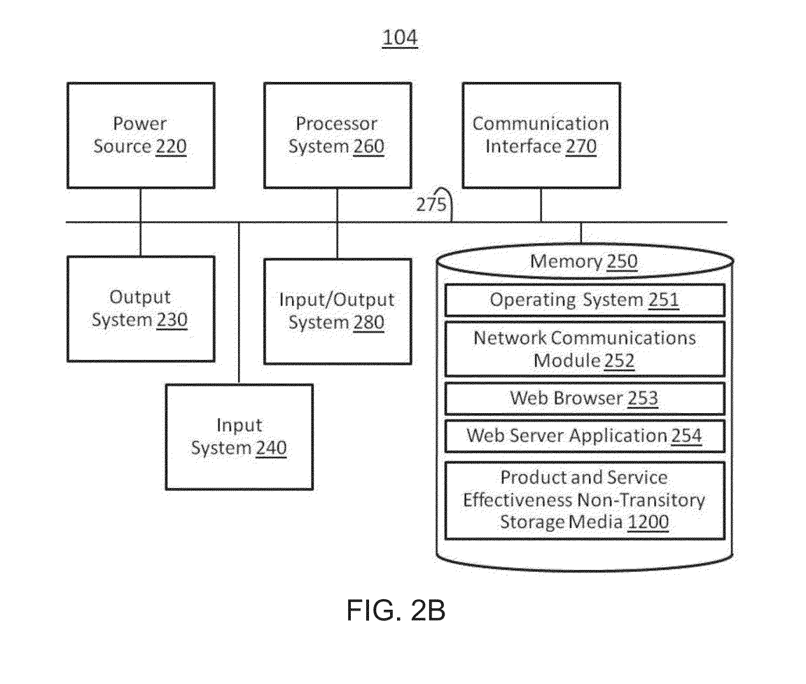

FIG. 2A illustrates a block diagram of a client system 200 that may be utilized as one of the system units for measuring and monitoring product and service effectiveness. The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld or mobile wireless device 122, SMARTPHONE® 124 or IPAD® 126 that may be utilized as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB). The memory system 206 may include, any one of, some of, any combination of or all of a long-term storage system, such as a hard drive, a short term storage system, such as a random access memory; a removable storage system, such as a floppy drive or a removable drive, and/or a flash memory. The memory system 206 may include one or more machine readable mediums that may store a variety of different types of information. The term machine readable medium may be utilized to refer to any medium that may be structurally configured for carrying information in a format that may be readable by a machine. One example of a machine-readable medium may be a computer-readable medium. The memory system 206 may store a non-transitory storage media for measuring and monitoring product and service effectiveness.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system 212 may communicatively link the output system 202, the input system 204, the memory system 206, the processor system 208, and/or the input/output system 214 to each other. The communications system 212 may include any one of, some of, any combination of, or all of one or more electrical cables, fiber optic cables, and/or means of sending signals through air or water (i.e., wireless communications), or the like. Some examples of means of sending signals through air and/or water may include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore may be an output device and accept input when the screens may be pressed by a finger or a stylus. The touch sensitive screens may be sensitive to heat, capacitance and/or pressure. One or more of the input/output devices may be sensitive to a voltage or a current produced by a stylus. The input/output system 214 is optional, and may be utilized in addition to or in place of the output system 202 and/or the input device 204.

The client systems 110, 114, 116, 118, 120 and the handheld wireless device 122 may also be tied into a website 216 or a wireless portal 218 which may also be tied directly into the communications system 212. Any website 216 or wireless portal 218 may also include a non-transitory storage media and a website module (not shown) to maintain, allow access to and run the website as well.

FIG. 2B illustrates a block diagram of a server system 104 that may be utilized for measuring and monitoring product and service effectiveness. The server system 104 may include a power source 220, an output system 230, an input system 240, a memory system 250, which may store an operating system 251, a communications module 252, a web browser module 253, a web server application 254 and a product and service effectiveness non-transitory storage media 1200. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB).

The memory system 250 may include any one of, some of, any combination of, or all of a long term storage system, such as a hard drive; a short term storage system, such as random access memory; or a removable storage system, such as a floppy drive or a removable drive and/or a flash memory. The memory system 250 may include one or more machine readable mediums that may store a variety of different types of information. The term machine readable medium may be utilized to refer to any medium capable of carrying information that may be readable by a machine. One example of a machine-readable medium may be a computer-readable medium such as a non-transitory storage media. The memory system 250 may store one or more machine instructions for measuring and monitoring product and service effectiveness. The operating system 251 may control all software and hardware of the system 100. The communications module 252 may enable the server system 104 to communicate on the communications network 112. The web browser module 253 may allow for browsing the Internet. The web server application 254 may serve a plurality of web pages to client systems that request the web pages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 may allow the server system 104 to interface with the network 112. In this embodiment, the output system 230 may send communications to the communication interface 270. The communications system 275 communicatively links the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water may include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore may be an output device and accept input when the screens may be pressed by a finger or a stylus. The touch sensitive screens may be sensitive to heat and/or pressure. One or more of the input/output devices may be sensitive to a voltage or a current produced by a stylus. The input/output system 280 may be optional and may be utilized in addition to or in place of the output system 230 and/or the input device 240.

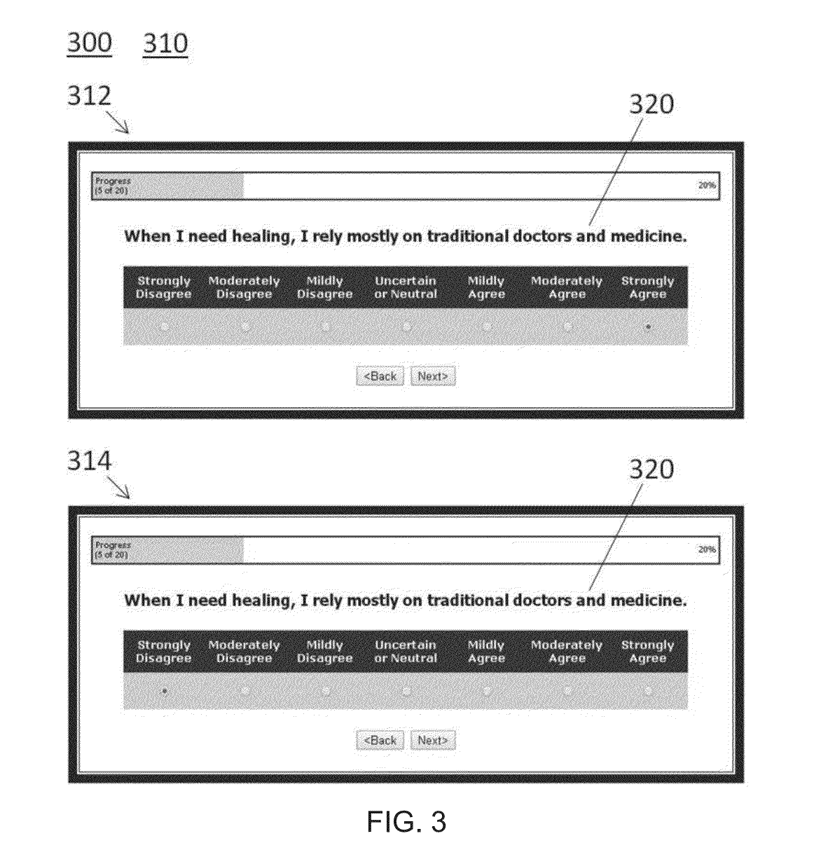

FIG. 3 illustrates a screenshot 300 of a pair of assessment statements ratings 310. The pair of assessment statements ratings 310 may reside on the web pages to measure and monitor product and service effectiveness.

The pair of sample assessment ratings 310 may include a before system rating 312 and an after system rating 314. The pair of sample assessment ratings 310 may rate one or more assessment statements 320. FIG. 3 illustrates an assessment statement 320 of “When I need healing, I rely mostly on traditional doctors and medicine” although any other suitable assessment statement may be utilized. One or more users may submit responses to one or more assessment statements 320 on a 6-point scale ranging from “Strongly Disagree” to “Strongly Agree,” as illustrated in FIG. 3. The provider may be worked with closely to develop the one or more assessment statements 320 that best capture the changes the users of their product or service may be expected to experience.

Each assessment statement 320 may have a positive normal score or a negative reversed score. Consider the assessment statement “I exercise for 20 minutes at least five times per week.” In this case, Strongly Disagree would be bad (worth 0 points) and Strongly Agree would be good (worth 6 points), higher scores indicating better results. However for the assessment statement, “I exercise less than once per month,” Strongly Disagree would be good and Strongly Agree would be bad. For these reversed assessment statements, the scoring may be reverse, so that Strongly Disagree may be worth 6 points and Strongly Agree may be worth 0 points. The assessment statements 320 may be a mixture of normal and reversed statements to keep users engaged. FIG. 3 illustrates a reversed statement and an ideal before-after situation, the maximum before-after change.

The provider's effectiveness may be evaluated by performing a periodic statistical analysis based on changes in the users' responses after experiencing the provider's product or service compared to the responses they provided before experiencing the product or service.

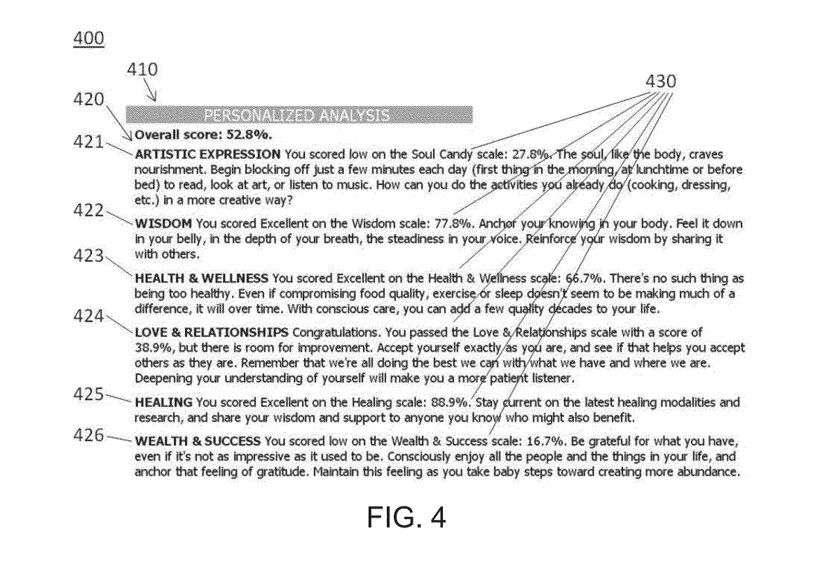

FIG. 4 illustrates a screenshot 400 of a plurality of personalized score-based feedback results 410. The personalized score-based feedback results may reside on the web pages to measure and monitor product and service effectiveness.

The personalized score-based feedback results 410 may include a plurality of assessment statement categories 420 that may include Artistic Expression 421, Wisdom 422, Health and Wellness 423, Love and Relationships 424, Healing 425, and Wealth and Success 426 or any other suitable assessment statement categories, and score-based content 430 for each assessment statement category 420. The assessment statement categories 420 may include one or more assessment statements 320. The provider may be worked with closely to develop the one or more assessment statement categories 420 that best capture the changes the users of their product or service may be expected to experience.

The total number of assessment statements 320 should be kept to a minimum needed to fully explore and adequately quantify the changes a user may be expected to experience. At least three assessment statements 320 may be needed in each of the assessment statement categories 420 so a data analysis may be meaningful, but in general fewer may be better. Too many assessment statements 320 and the user may get bored, frustrated by the time commitment, and potentially abandon the assessment quiz before seeing the personalized score-based feedback results 410. The order in which the assessment statements 320 may be presented to the user may be preferably pseudo-randomized rather than grouped by assessment statement category 420.

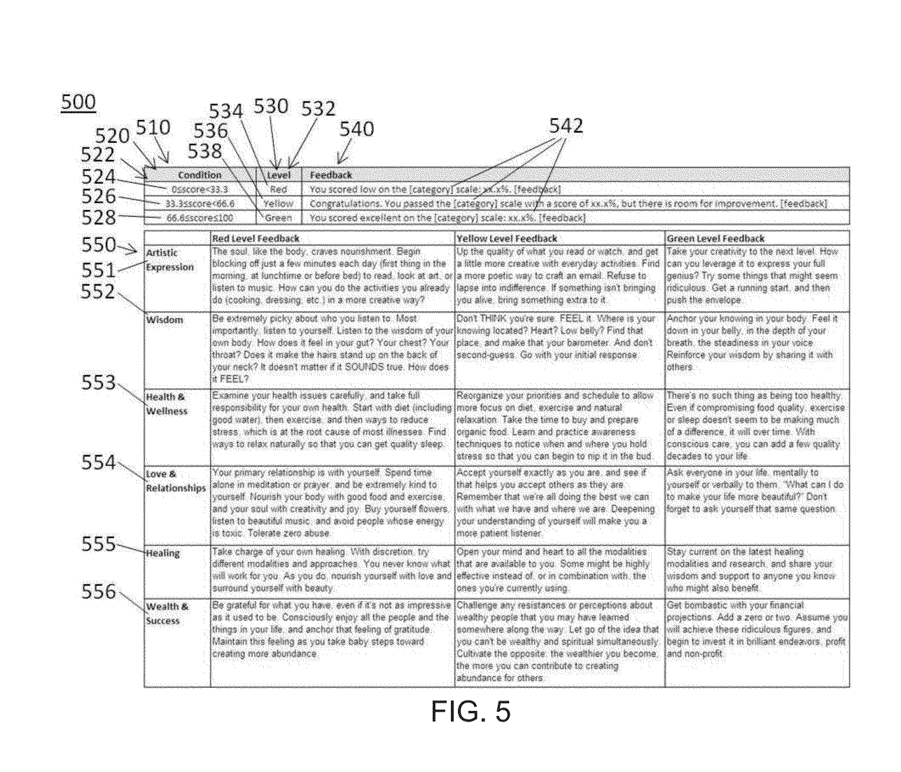

FIG. 5 is a table 500 of a plurality of score-based feedback 510. The score-based feedback 510 may reside in the non-transitory storage media (FIG. 2B, 1200) to measure and monitor product and service effectiveness and may be selectively presented to the user as shown in FIG. 4.

The score-based feedback 510 may include a condition 520, a level 530, a plurality of feedback 540 and a plurality of score-based feedback statements 550 in assessment statement categories 420 that may include Artistic Expression 421, Wisdom 422, Health and Wellness 423, Love and Relationships 424, Healing 425, Wealth and Success 426 or any other suitable assessment statement categories. The condition 520 may be in a range score 522 with 0 to 33.3 524, 33.3 to 66.6 526, and 66.6 to 100 528, or the like. The higher the range score 522, the better the condition 520 of the user. The level 530 may be a colored code identifier 532 where a red color 534 may represent a poor performance level, a yellow color 536 may represent an average performance level and a green color 538 may represent an excellent performance level. The level 530 may be denoted by any other suitable identifier or no identifier based on the needs of the provider. The feedback 540 may include an appropriate comment 542 regarding the level 530 achieved by the user. The assessment statement categories 420 may include a condition 520, a level 530 and a plurality of feedback 540 applied to each assessment statement category 420.

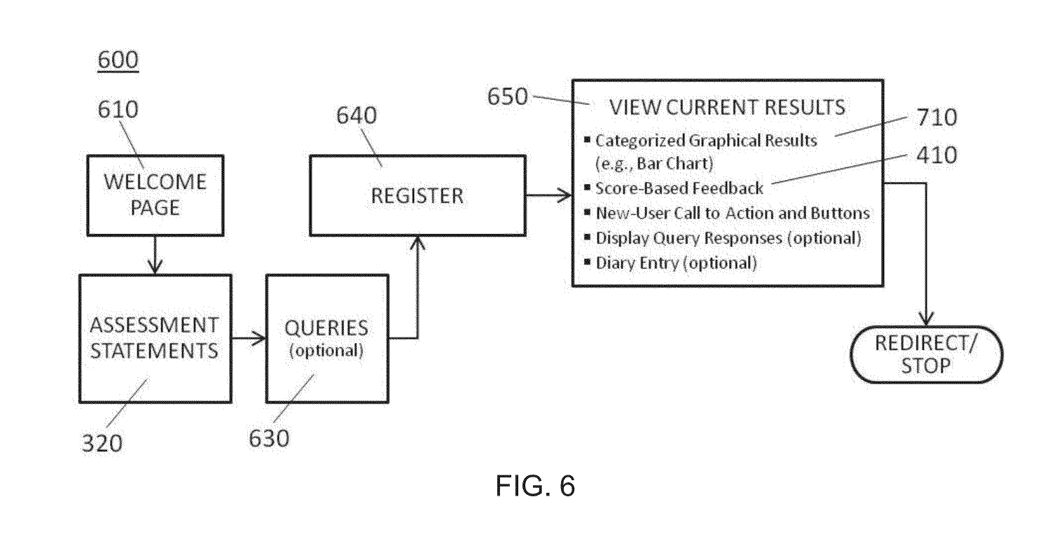

FIG. 6 illustrates a flowchart of a method 600 for measuring and monitoring product and service effectiveness as experienced by a new user taking an assessment quiz before they have interacted with the provider's product or service. The method 600 may include the steps of accessing a welcome webpage 610, submitting a plurality of assessment statements 320, responding to one or more optionally-available queries 630, registering 640, and viewing current results 650.

The accessing a welcome webpage 610 may include accessing a website typically online, but it may be on any suitable communications network or device. The assessment statements 320 may be part of a pre-post assessment quiz. The assessment quiz results may be provided back to a user in real time, and the assessment quiz may be taken as often as desired. The step of responding to one or more queries 630 may be an optional part of the assessment quiz including assessment statements 320. A plurality of queries 630 may include but may be not limited to open-ended questions, multiple choice questions and diary entries. The registering 640 may include entering an email address, password, and/or any other identifying information requested by the provider to enable the user to log-in to the assessment quiz again after they have interacted with the provider's product or service. The viewing of current results 650 may involve the display of the user's current categorized graphical results 710, a plurality of score-based feedback 410 as illustrated in FIG. 4, a new-user call to action and other buttons and display features desired by the provider.

In addition to the queries 630, the inventive system may optionally accommodate diary entries. FIG. 6 illustrates the registering 640 in method 600 after the assessment statements 320 and queries 630 steps and before the view current results 650. Registering 640 may alternatively be incorporated at any suitable position in the method 600 to meet the needs of the provider.

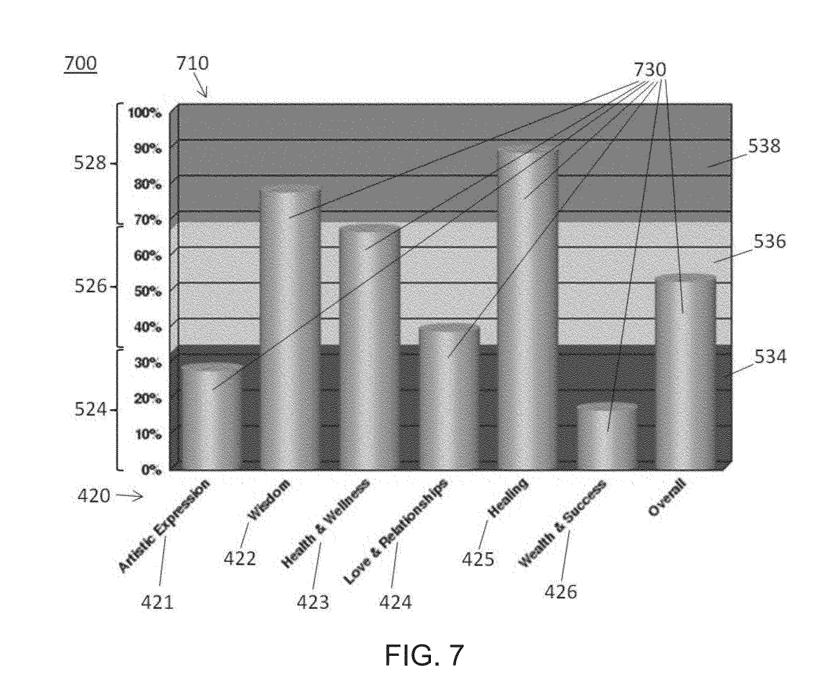

FIG. 7 illustrates a screenshot 700 of categorized graphical results 710. The categorized graphical results 710 may reside on the web pages to measure and monitor product and service effectiveness.

The sample categorized graphical results 710 may include a plurality of assessment statement categories 420 that may include Artistic Expression 421, Wisdom 422, Health and Wellness 423, Love and Relationships 424, Healing 425, and Wealth and Success 426 or any other suitable assessment statement categories. The categorized graphical results 710 may illustrate the user's scores 730 for each assessment statement category 420. The user's scores may be the total of the user's points divided by the maximum possible total number of points for each assessment statement category 420 or any other suitable measurement methodology. The user's scores 730 may include an overall score represented by the average of the scores for each assessment statement category 420 or other suitable overall score representation.

The user's score 730 for each assessment statement category 420 may be represented graphically by the height of a bar although any other suitable graphical representation may be utilized. The user's scores may be shown on a color-coded background keyed to the range scores 522 and colored code identifiers 532 illustrated in FIG. 5. FIG. 7 illustrates red 534, yellow 536 and green 538 backgrounds (colors shown in grayscale) that may be keyed to range scores 0 to 33.3 524, 33.3 to 66.6 526, and 66.6 to 100 528, respectively. Any other suitable range scores and colored code identifiers may be utilized. FIG. 7 illustrates categorized graphical results 710 utilizing a bar chart although any other suitable graphical representation may be utilized.

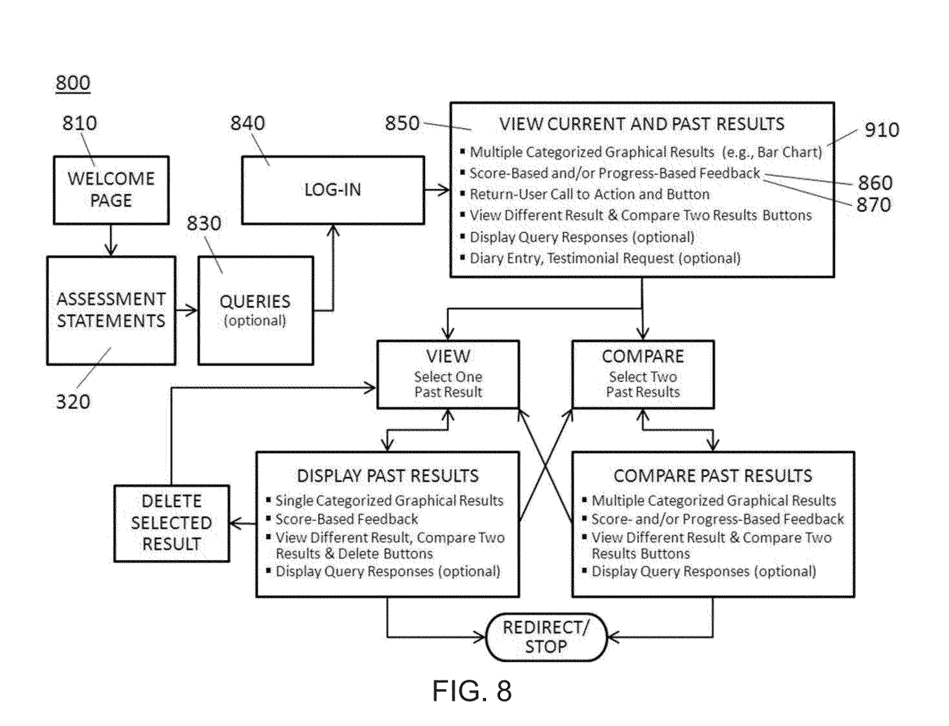

FIG. 8 illustrates a flowchart of a method 800 for measuring and monitoring product and service effectiveness as experienced by a return user taking an assessment quiz again after they have interacted with the provider's product or service. The method 800 may include the steps of accessing a welcome webpage 810, submitting a plurality of assessment statements 320, responding to one or more optionally available queries 830, logging-in 840, and viewing current and past results 850.

The accessing a welcome webpage 810 may include accessing a website typically online, but it may be on any suitable communications network. The assessment statements 320 may be part of a pre-post assessment quiz. The step of responding to one or more queries 630 may be an optional part of the assessment quiz including assessment statements 320. A plurality of queries 630 may include but may be not limited to open-ended questions, multiple choice questions, diary entries and testimonial requests. The log-in 840 may include entering an email address and password and/or any other identifying information required by the provider. The viewing of current and past results 850 may involve the display of the user's current and past categorized graphical results 910, score-based feedback 860 and/or progress-based feedback 870, a return-user call to action and other buttons and display features desired by the provider.

In addition to the queries 830, the inventive system may accommodate diary entries and/or testimonial requests. FIG. 8 illustrates the log-in 840 in method 800 after the assessment statements 320 and queries 830 steps and before the view current and past results 850. Log-in 840 may alternatively be incorporated at any suitable position in the method 800 to meet the needs of the provider.

The viewing of current and past results 850 may accommodate display of the user's score-based feedback 860 as current score-based feedback 410 as illustrated in FIG. 4, as both current and past score-based feedback, and/or as progress based feedback 870. Progress-based feedback may provide content based on whether the user's scores increased, decreased, or stayed the same.

The log-in and viewing current and past results 850 may be specifically for a return user, and the return user may access the past results one or more times and compare the past results one or more times. As desired, past results may be deleted as well. Once a new user may access and completes the assessment quiz and registers, the user may be considered a return user and may access, view and compare past results as desired.

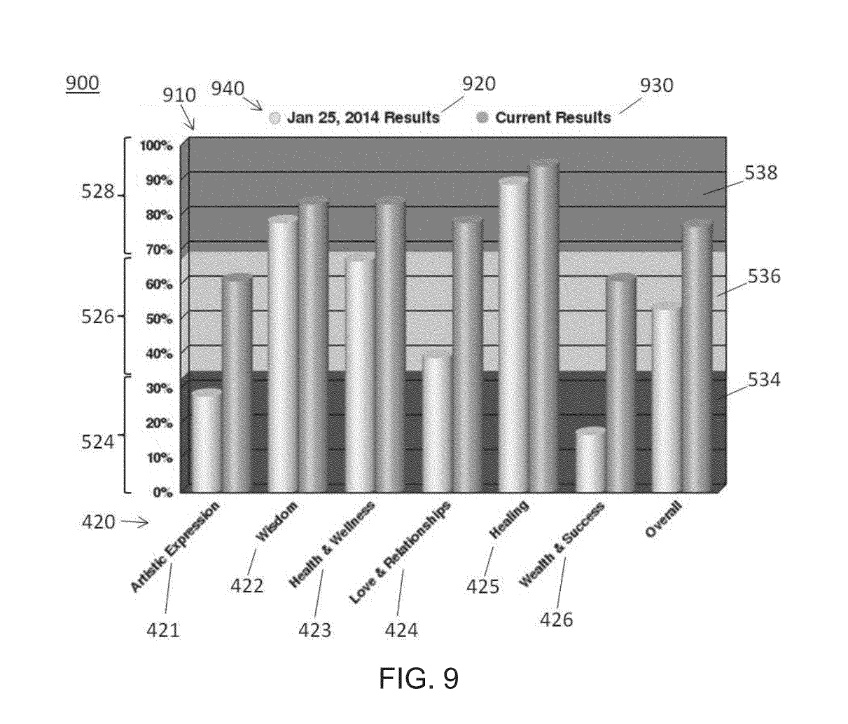

FIG. 9 illustrates a screenshot 900 of multiple categorized graphical results 910. The categorized multiple graphical results 910 may reside on the web pages to measure and monitor product and service effectiveness.

The sample multiple categorized graphical results 910 may include a plurality of assessment statement categories 420 that may include Artistic Expression 421, Wisdom 422, Health and Wellness 423, Love and Relationships 424, Healing 425, and Wealth and Success 426 or any other suitable assessment statement categories. The categorized graphical results 910 may illustrate the user's past scores 920 and current scores 930 for each assessment statement category 420. The user's scores may be the total of the user's points divided by the maximum possible total number of points for each assessment statement category 420 or any other suitable measurement methodology. The user's scores 920 and 930 may include an overall score represented by the average of the scores for each assessment statement category 420 or other suitable overall score representation.

The user's past scores 920 and current scores 930 for each assessment statement category 420 may be represented graphically by the height of a bar although any other suitable graphical representation may be utilized. The legend 940 may denote the user's past score 920 as “Jan. 25, 2014 Results” in FIG. 9 although any appropriate past result date denotation may be shown. The legend 940 may denote the user's current score 930 by “Current Results” in FIG. 9 although any appropriate denotation may be utilized.

The user's scores may be shown on a color-coded background keyed to the range scores 522 and colored code identifiers 532 illustrated in FIG. 5. FIG. 9 illustrates red 534, yellow 536 and green 538 backgrounds (colors shown in grayscale) keyed to range scores 0 to 33.3 524, 33.3 to 66.6 526, and 66.6 to 100 528, respectively. Any other suitable range scores and colored code identifiers may be utilized.

FIG. 9 illustrates multiple categorized graphical results 910 utilizing a bar chart although any other suitable graphical representation may be utilized. FIG. 9 further illustrates two categorized graphical results 910 although any suitable number of categorized graphical results may be presented. FIG. 9 further illustrates a set of past scores 920 and a set of current scores 930 although one or more past scores sets may be represented.

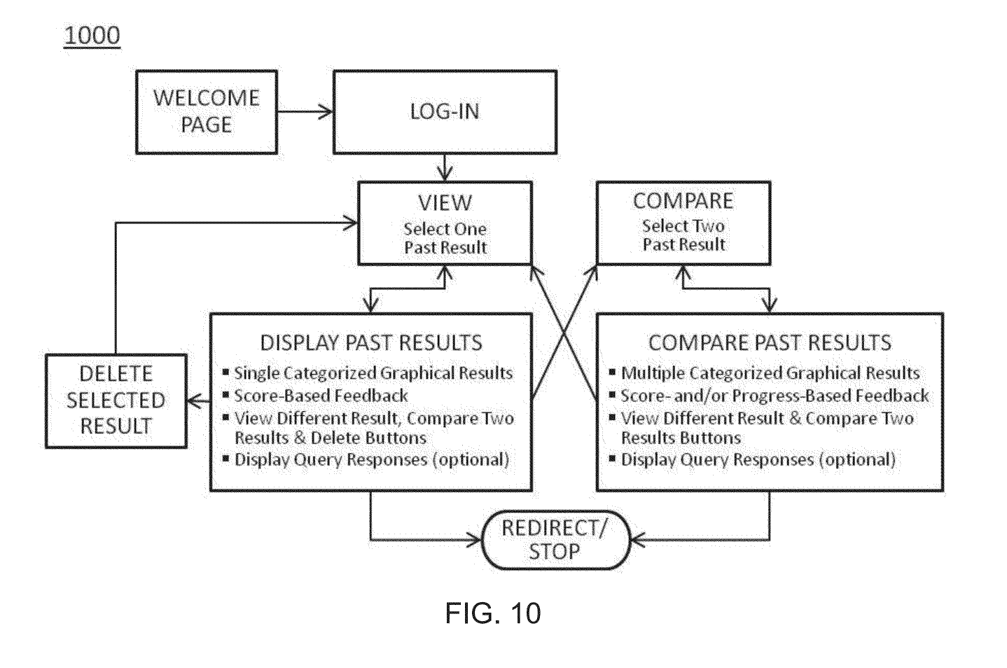

FIG. 10 illustrates a flowchart of a method 1000 for measuring and monitoring product and service effectiveness as experienced by a return user accessing past results. The method 1000 may accommodate direct log-in of a return user without taking the assessment quiz and may include the steps of accessing a welcome webpage, logging-in, selecting and viewing a past result, and optionally comparing two past results and/or deleting a past result.

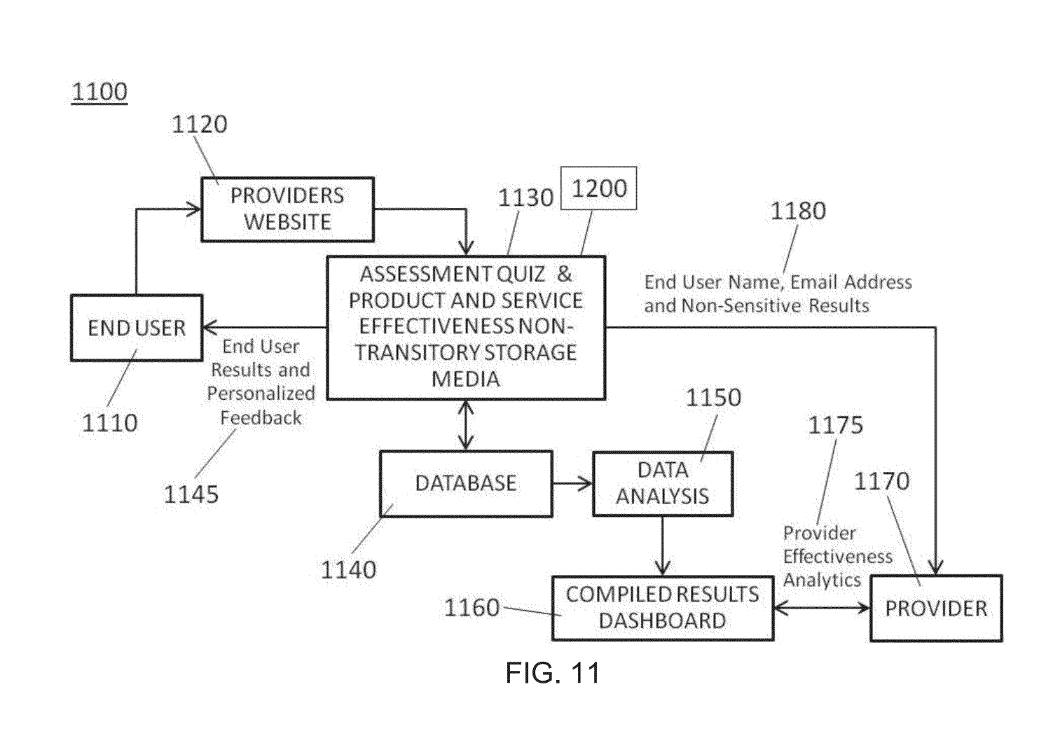

FIG. 11 illustrates an overview flowchart of the method 1100 for measuring and monitoring product and service effectiveness. The method 1100 may include the steps of an end user 1110 accessing a provider's website 1120, accessing and taking an assessment quiz 1130 operated by a product and service effectiveness non-transitory storage media 1200. The method 1100 may further include the steps of the product and service effectiveness non-transitory storage media 1200 presenting the results to the user 1110 and saving the user results to and accessing the user results from the database 1140. Method 1100 may further include the steps of analysis of the collective results 1150 and display of the compiled results via a dashboard 1160 to the provider 1170.

Accessing a provider's website 1120 may include accessing a website typically online but may be on any suitable communications network or device that may be designed for an end user 1110. The accessing and taking an assessment quiz 1120 may include submitting a plurality of assessment statements. The product and service effectiveness non-transitory storage media 1200 may reside on a separately hosted quiz website or may be presented to the user via any suitable pop-up website window technology such as jQuery modals or video format or FRAMES® on the provider's website 1120. The product and service effectiveness non-transitory storage media 1200 may write the user results to a MySQL or any other suitable database 1140 for storage and reads information from the database 1140 to present categorized results and personalized feedback 1145 to the user 1110 in real time. The analysis of the collective results 1150 may include reading a plurality of results for all users from the database 1140, conducting a statistical effectiveness evaluation based on changes in the users' responses after experiencing the provider's product or service compared to the responses they provided before experiencing the product or service, and publishing the results of the analysis to a compiled results dashboard 1160. The provider 1170 may then access the compiled results dashboard 1160 to view their effectiveness analytics 1175.

The method 1100 accommodates the product and service effectiveness non-transitory storage media 1200 providing end user name, email address and any other suitable non-sensitive results 1180 to the provider via email or any other suitable delivery method.

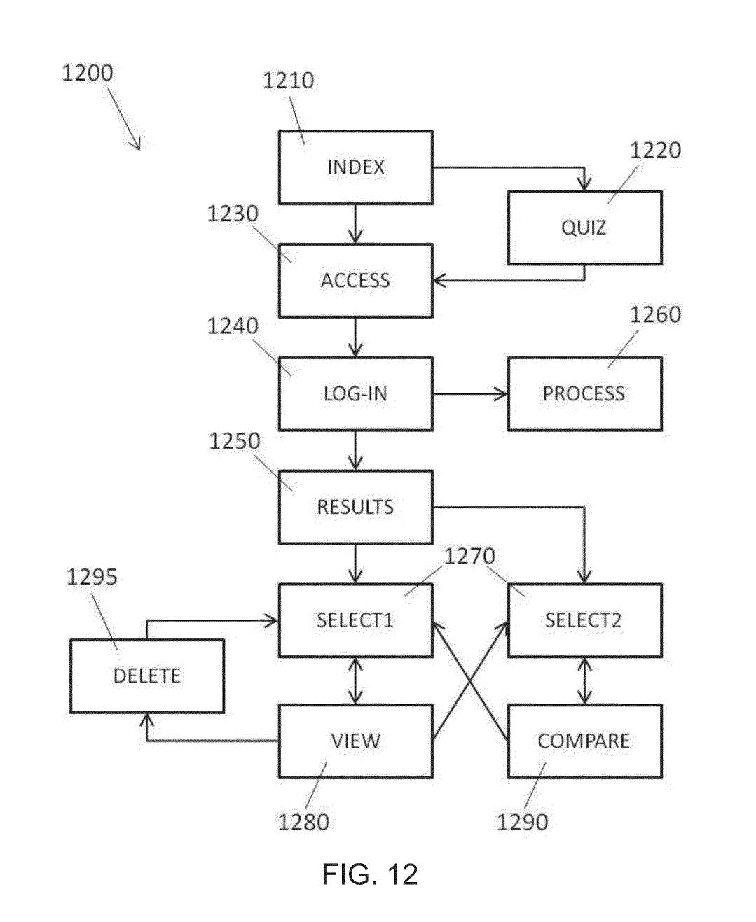

FIG. 12 illustrates a block diagram of a product and service effectiveness non-transitory storage media 1200. The product and service effectiveness non-transitory storage media 1200 may include an index module 1210, a quiz module 1220, an access module 1230, a log-in module 1240, a results module 1250, a process module 1260, a pair of select modules 1270, a view module 1280, a compare module 1290 and a delete module 1295. The index module 1210 may indicate a plurality of session-related information of the type of user accessing the product and service effectiveness non-transitory storage media 1200. The quiz module 1220 may control a plurality of radio buttons and a plurality of text entries as well as some session-related information. The access module 1230 may allow a user to enter and confirm email information and includes processing for the last assessment quiz information. The log-in module 1240 may allow log-in to the product and service effectiveness non-transitory storage media 1200 for return users, checks email information and includes collecting profile information for new users and password reset functionality. The results module 1250 may be accessed by the log-in module 1240 and displays the current and past results of a return user's assessment quiz information. The process module 1260 may include checking the information and creating a profile for a new user and may display the current results of a new user's assessment quiz information. The select modules 1270 may display all of the user's assessment quizzes by the date and time the assessment was originally taken and may enable the user to select a single result to display or two results to compare. The view module 1280 may display the results of the one assessment quiz. The compare module 1290 may display the results of two assessment quizzes side by side. The delete module 1295 may enable a user to delete a quiz result from the database.

The present invention enables end customers to measure and track the results they experience as a result of interacting with a product or a service. The present invention further enables product and service providers to measure the effectiveness of their solution and provide automated score-based feedback to their customers.

End customers are invited to take an assessment both before and after they interact with a provider's product or service. The assessment is customized to measure the changes the provider expects their customers to experience based on their specific solution. The customer views their assessment results in real time and may compare before and after results side by side.

Before-after assessment results from all users are compiled and analyzed to provide effectiveness analytics to the business. These results may be utilized to substantiate and advertise that their product or service works as promised and to indicate areas of their solution that need improvement. The present invention provides independent evaluation of the quality and effectiveness of products and services.

While the present invention has been related in terms of the foregoing embodiments those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A system to measure and monitor product and service effectiveness, comprising:
a server system with a processor system, a communications interface, a communications system, an input system and an output system, the server system having access to a communications network;
a memory system with an operating system, a communications module, a web browser module, a web server application and a product and service effectiveness non-transitory storage media; and
a website with a plurality of web pages to measure and monitor product and service effectiveness, the web pages include a pair of assessment statements ratings that reside on the web pages to measure and monitor product and service effectiveness, the assessment statements ratings include a before system rating and an after system rating and present an assessment quiz result back to a user in real time, the user takes the assessment quiz as often as desired, and a plurality of score-based feedback reside on the web pages to measure and monitor product and service effectiveness.

2. The system according to claim 1, further comprising a client system, the client system includes an output system, an input system, a memory system, a processor system and a communications system.

3. The system according to claim 2, wherein the client system accesses the server system via the communications network.

4. The system according to claim 2, wherein the client system is a cell phone or a tablet with an operating system.

5. The system according to claim 1, wherein the personalized results feedback includes a plurality of assessment statement categories.

6. The system according to claim 5, wherein the assessment statement categories include Artistic Expression, Wisdom, Health and Wellness, Love and Relationships, Healing and Wealth and Success.

7. The system according to claim 1, wherein the score-based feedback includes a condition and a level.

8. The system according to claim 7, wherein the condition is in a range score.

9. The system according to claim 8, wherein the range score is a selected one of 0 to 33.3, 33.3 to 66.6 and 66.6 to 100.

10. The system according to claim 7, wherein the level is a colored code identifier.

11. The system according to claim 10, wherein the colored code identifier is a red color representing a poor performance level, a yellow color representing an average performance level and a green color representing an excellent performance level.

12. The system according to claim 1, wherein the score-based feedback is based on changes in scores over time.

13. The system according to claim 1, further comprising a plurality of categorized graphical results that reside on the web pages to measure and monitor product and service effectiveness.

14. The system according to claim 13, wherein the plurality of categorized graphical results is presented on a colored code background keyed to range scores.

15. The system according to claim 1, wherein the communications network is the Internet.

16. The system according to claim 1, wherein the product and service effectiveness non-transitory storage media includes an index module, a quiz module, an access module, a log-in module, a results module, a process module, a pair of select modules, a view module, a compare module and a delete module.

17. A method for measuring and monitoring product and service effectiveness, comprising the steps of:
accessing a welcome webpage;
submitting a plurality of assessment statements;
responding to one or more optional queries; and
logging-in and viewing current results and a plurality of past results.

18. The method according to claim 17, wherein the welcome webpage, the assessment statements, the one or more optional queries and the current and past results reside on a plurality of web pages to measure and monitor product and service effectiveness.

19. A method for measuring and monitoring product and service effectiveness, comprising the steps of:
accessing a provider's website;
accessing a plurality of assessment statements on a database run by a data analysis non-transitory storage media; and
accessing a results dashboard with a plurality of compiled user results.

20. The method according to claim 19, wherein the provider's website, the assessment statements on the database run by the data analysis non-transitory storage media and the results dashboard with the compiled user results reside on the web pages to measure and monitor product and service effectiveness.
